(19) United States
(12) Patent Application Publication
(10) Pub. No.: US 2014/0279800 A1
(43) Pub. Date: Sep. 18, 2014

(54) Systems and Methods for Artificial Intelligence Decision Making in a Virtual Environment

(71) Applicant: AGINCOURT GAMING LLC, Allen, TX (US)

(72) Inventor: Nikolaos Anastasopoulos, Voula (GR)

(73) Assignee: AGINCOURT GAMING LLC, Allen, TX (US)

(21) Appl. No.: 13/828,977

(22) Filed: Mar. 14, 2013

(51) Int. Cl. G06N 5/02

(52) U.S. Cl. CPC G06N 5/025
USPC 706/47

(57) ABSTRACT

Disclosed is a AI decision making solution under which the actions, reactions and behavior of an AI entity are defined in a virtual environment. In addition to gathering user interactive data within a given scenario, the disclosed principles also provide for a periodic analysis of the entire virtual environment, regardless of user interaction. This allows the disclosed AI entity to make more accurate decisions by constantly taking into account the status of the environment in addition to user interactions with the environment or other characters. Also, the disclosed principles provide an AI solution capable of modifying not only the weights assignable to data used in the decision making process, but also modifying the actual rules of the decision making process itself depending on the gathered and analyzed weighted data. As a result, the disclosed AI entity is capable of making varying decisions on the same or similar collection of data.

### TECHNICAL FIELD

The present disclosure relates generally to local or online gaming environments, and more specifically to artificial intelligence (AI) decision making systems and related processes under which the actions, reactions and behavior of an AI entity can be defined in the virtual environment.

### BACKGROUND

It is well known that the Internet has transformed our world, and currently long distances between people and locations are considered almost nonexistent when it comes to the receiving and sending of information. The entire world has been transformed into a virtually smaller place where people from all over the world can access information and communicate with other people instantly, without any regard to the distance. It is only logical to say that the internet is providing a common space for users from all over the world to connect and interact with each other.

In addition to the exchange of information between users, technology has also made the creation of gaming environments into virtual environments where users can entertain themselves. Over the past few years, multiplayer games have become very famous and are enjoyed by millions of people worldwide. Social interaction in multiplayer games is very important. The need for a mechanism that, under a set of rules and specifications, brings together users who know each other and, perhaps more importantly, those who are not familiar with each other, is very important. This is especially the case when competition is an element of the gaming environment, and unfairness could create a bad gaming experience.

In a local or online competitive graphical environment, users struggle to accomplish one or more goals following a set of rules in order to gain a victory against another user or against the AI of the environment. The AI is typically a computing entity that has been designed to act and respond to a human user's actions so as to resemble a human opponent. The more complicated the set of rules of a local or online graphical environment is and under which the human users need to act so as to accomplish a goal or goals, the more complicated is the set of rules and conditions that the AI entity needs to follow to provide a competitive experience that is balanced between fair and challenging. For example, a game such as Tic Tac Toe has very simple game rules, is very fast paced and the AI entity has little possibility for providing a challenge or new tactics. However, in games that consist of a more complicated set of rules and there is scope in the game for innovative actions, such as Chess, a sufficiently well designed AI entity could provide a fair challenge to a user and thus provide a satisfactory gaming experience to the user.

For game developers and developers of local or online competitive graphical environments in general, the challenge of creating a sufficiently well designed AI entity can mean the success or the failure of such a product since it affects the user experience, and therefore, to a great extent, the satisfactory level of the user related to the graphical environment. Accordingly, what is needed in the art is an advanced AI entity capable of providing such a satisfactory level of experience, while not suffering deficiencies of conventional approaches to the AI decision making process.

### SUMMARY

This summary is provided to describe certain aspects of embodiments of the invention. It is not intended to show the essential features of the invention nor is it intended to limit the scope of the claims.

Disclosed herein are AI decision making systems and related processes under which the actions, reactions and behavior of an AI entity can be defined, for example, in a virtual gaming environment. Thus, these systems and processes provide a competent opponent for a human user, human users in a cooperative gameplay mode, or even human user teams consisting of several human users versus the AI, along with expandability and easy data manipulation capabilities. The disclosed approach covers all aspects for the designing of an AI entity, and can handle a range of activities from the simplest set of decision making rules to very complicated conditions and rules. In addition to a typical gathering of user interactive data within a given scenario of a virtual environment, the disclosed principles also provide for a periodic analysis of the entire virtual environment, regardless of user interaction at the time of that analysis. This allows the novel AI entity to make more accurate decisions since it constantly takes into account the status of the environment along with any user interaction with the environment or other characters present in the environment. Also, the disclosed principles provide an AI engine capable of modifying not only the weights assignable to data used in the decision making process, but also modifying the actual rules of the decision making process itself depending on the gathered and analyzed weighted data. As a result, an AI entity implemented as disclosed herein is capable of making varying decisions on the same or similar collections of data depending on the weighting given to the collected data. The disclosed principles also provide for a “self-learning” technique that can make the AI entity more challenging as its actions, reactions and behavior in general can dynamically improve from the default settings, making it more challenging and providing a more unique experience to the user.

In one embodiment, a method of decision making for an AI entity in a graphical virtual environment according to the disclosed principles may comprise gathering data on which a decision will be based from the virtual environment, assigning weight values to at least some of the gathered data, and analyzing the weighed data to determine an initial set of decision making rules. Additionally, in such an embodiment, the method may include comparing the initial set of decision making rules to the weighted data, and adjusting the initial set of decision making rules based on the comparison to create an adjusted set of decision making rules. Such exemplary methods may also comprise determining a decision based on the weighed data using the adjusted set of decision making rules, and executing the resulting decision determined using the adjusted set of decision making rules.

In another aspect, a computer system providing an AI entity in a virtual gaming environment is provided. In one embodiment, the system comprises a server device and associated software for hosting a virtual gaming environment along with a data storage facility for storing virtual entities for use by corresponding users in the virtual environment, and for storing gathered data on which decisions made by an AI engine will be based. In addition, such an exemplary system may further comprise a computing device and associated software associated with the server device and data storage for providing an AI decision making engine. Such an AI engine may be configured to assign weight values to at least some of the gathered data, and analyze the weighed data to determine an initial set of decision making rules. The AI engine may also be configured to compare the initial set of decision making rules to the weighted data, and adjust the initial set of decision making rules based on the comparison to create an adjusted set of decision making rules. Furthermore, an exemplary AI engine may be configured to then determine a decision based on the weighed data using the adjusted set of decision making rules, and execute the decision determined using the adjusted set of decision making rules.

### BRIEF DESCRIPTION OF THE DRAWINGS

Embodiments are illustrated by way of example in the accompanying figures, in which like reference numbers indicate similar parts, and in which:

FIG. 1 illustrates a flow diagram setting forth one embodiment of the logic for determining the behavior of the AI entity in a local or online graphical environment, in accordance with the disclosed principles;

FIG. 2 illustrates a flow diagram setting forth one embodiment of how an AI entity in accordance with the disclosed principles follows a set of rules for the graphical environment used in its decision making operation;

FIG. 3 illustrates a flow diagram setting forth one embodiment of when and under which circumstances the behavioral logic of an AI entity in accordance with the disclosed principles may take action;

FIG. 4 illustrates a flow diagram setting forth one embodiment of the assignment of weights on a predetermined number of data items collected from the graphical environment and the interaction of the user with the latter;

FIG. 5 illustrates a flow diagram setting forth one embodiment of the decision making process of an AI entity according to the disclosed principles; and

FIG. 6 illustrates a block diagram setting forth one embodiment of an exemplary self-learning process under which an AI entity in accordance with the disclosed principles can improve its decision making process.

### DETAILED DESCRIPTION

Looking initially at FIG. 1, illustrated is a flow diagram 100 setting forth one embodiment of the logic for determining the behavior of the AI entity in a local or online graphical environment. At step 105, for example, the AI entity is initiated when gameplay is started in a virtual gaming environment. Each graphical environment, whether local or online, has a set of rules determined in step 110 for governing gameplay and one or more goals players seek to achieve. By using this set of rules, users are challenged to perform in a way that will gain them an advantage over another user (individual users or human user teams) or an AI entity so as to accomplish the goal or goals defined by the graphical environment.

In some embodiments, the AI entity may have to follow exactly the same set of rules as the users in the virtual environment. In related embodiments, the users may be able to choose among different levels of difficulty offered by the graphical environment. Thus the AI entity can follow different sets of rules depending on the level of difficulty chosen. At step 115, the level at which the AI entity will operate is determined. This level may or may not correspond to the difficulty level selected by the user. Accordingly, items like armor, strength, dexterity, damage dispensed, experience level, etc. of a virtual entity (VE) in which are characters controlled by users or the AI in a virtual environment, may change and determined by the set of rules to be used based on the difficulty level selected. Thus, based on the selected level of difficulty, the AI entity will follow Version 1, Version 2, . . . Version X (120a-120c) of the graphical environment's set of rules.

While the different sets of rules can be predetermined in advantageous embodiments of the disclosed principles, the sets of rules can also be dynamically set according to conditions related to the status of the user(s) interacting with the graphical environment as well as possibly the status of the overall environment itself. In such situations, the AI entity may detect certain triggers during gameplay, as shown in step 125, which will activate or affect its behavioral logic and thereby determine what actions or reactions to undertake. Alternatively in accordance with the disclosed principles and as discussed in further detail below, an AI entity according to the disclosed principles may not await a specific trigger created by a user in order to act. Instead, the disclosed AI entity may continuously conduct a periodical analysis of the entire gaming environment, for example, every two milliseconds, although any desired time period may be used, to determine if an environmental trigger is detected and thus whether a decision should be made even without affirmative action by a user. The AI entity may select the appropriate set of rules to employ in its decision making process for taking a given action based on, for example, the difficulty level of the AI entity. In a more specific embodiment, the AI entity has several levels of difficulty from which the user has chosen one in a prior moment and before the initiation of the competitive interaction between the user and the AI entity. This may be illustrated by the initial AI entity level shown in step 130.

Then, at step 135, depending on the AI entity's level, the AI entity may use a specific or dynamic set of rules and conditions to analyze the current situation at the time of the trigger and gather the necessary data to initiate its behavioral logic. Once all the necessary data are collected and if a static level for the AI entity has been established, the AI entity has only one level and therefore only one identity. That pre-established level is employed on the collected data at step 140. Alternatively in other embodiments, the level of the AI entity may change prior to a decision being made, for example, based on the analysis of the collected data. In such embodiments, the AI entity will use a dynamic set of rules and conditions and it will interpret the collected data and proceed to a specific action or reaction, or a series of actions or reactions, in the decision making process using the selected set of rules and conditions. Whether the decision making rules and conditions used by the AI entity are static or dynamic, at step 145 the AI entity will employ the appropriate set of rules, execute a decision making process (which is discussed in detail below), and act or react based on the decision made.

Furthermore, the disclosed system or process may also include a self-learning process for the AI entity. Thus, at step 150 it is determined if a self-learning process is present and enabled for the AI entity. If no self-learning process is present or enabled, then the disclosed process may simply return to step 125 where the AI entity awaits the next trigger (again, either due to actions by a user or as a result of an environmental analysis) that would cause another decision making process to be needed. If a self-learning process in accordance with the disclosed process is enabled in the process, after a decision is made by the AI entity the outcome of the decision made and the action taken by the AI entity is evaluated and stored for statistical analysis. When enabled, the self-learning process can improve the decision making process that the AI entity uses for its behavioral logic and situation analysis logic 0 and this way improve its effectiveness. The details of the self-learning process are discussed in further detail below.

Turning now to FIG. 2, illustrated is a flow diagram 200 setting forth how an AI entity in accordance with the disclosed principles follows a set of rules within the graphical environment used in its decision making operation. At step 205, a determination of the graphical environment will set the rules that the AI entity will follow is initialized. At step 210 the initial AI entity difficulty level is determined. As mentioned above, the set of rules and conditions to be employed by the AI entity may be static (block 215) and thus unchanging throughout the current gameplay or it may be dynamic (block 220) and therefore changeable during gameplay. This is typically determined based on the AI entity level settings. However, in other embodiments, this may be determined by a game mode offered by the system in order to increase the difficulty and offer a bigger challenge to the user(s). Also as before, the AI entity's level may match the user(s) selected level, or it may be a different level, for example, selected by the user.

At step 225, it is determined whether the level of the AI entity will be dynamic during gameplay. More specifically, different levels of difficulty can provide different sets of rules and conditions that can be predetermined for one or more established AI entity levels or they can be dynamically modified during gameplay according to the status of the user interacting with the graphical environment and/or the status of the environment as a whole. The mechanics of a graphical environment involve variables and constants during gameplay and altogether those variables and constants interact to create the rules and conditions under which users and AI entities operate in the graphical environment and under which goals are accomplished. When these variables and constants are analyzed by the AI entity during gameplay, the AI entity evaluates the data associated with the variables and constants and employs the established set of rules to make a decision with respect to action. In other embodiments of the disclosed principles, it is possible to alter the variables and/or constants based on an evaluation of the user's actions or status as well as the status of the environment and the success or failure of the AI entity's prior decisions in order to provide an advantage to the AI entity and thus make it a more competitive opponent for the user(s). In the case of a non-dynamic difficulty level, a number of predetermined set of rules (230a-230c) will apply to the AI entity and the specific set to be employed for the decision making process typically depends on the level matching or chosen by the user.

If the AI entity level is set to dynamic, the actual rules and conditions employed by the AI entity for the decision making process may be changed during gameplay, typically according to the status of the user and the status of the overall virtual environment, thus creating tailor made difficulties for the user(s). This is illustrated at step 235 of the process of FIG. 2. Such a custom made difficulty will be possible by evaluating one or more predetermined sets of data of both the user(s) and the environment and using the collected data to define the level of modification of the set of rules and conditions that the AI entity will employ for its decision making. Moreover, if the self-learning process is enabled, the success or failure of the AI entity's previous decisions may also be employed to alter the set of rules to be employed for decision making. At step 240, once the AI entity takes into account one or more of the aspects of the disclosed principles discussed above, the set of rules it will follow for its decision making process is then altered at step 240.

Altering the set of rules to be used for the decision making process in this dynamic manner differs from conventional AI entities in that with conventional approaches AI entities make different decisions based on the weight values assigned to certain data used for a given decision. However with the disclosed principles, not only can the weight values assigned to various data points be altered as discussed above but the actual rules of how the weight of those data points will be evaluated may also be changed. Accordingly, while a set of weight values for a collection of data points results in a conventional AI entity reaching a certain decision, an AI entity according to the disclosed principles may make a different decision for each time it evaluates the same collection of weight values depending on what set of rules are currently being employed by the AI entity. This results in a particularly unique AI decision making process in that it can provide user(s) with a unique gameplay experience each time they play even within the same part of a virtual environment. When combined with the self-learning process disclosed herein, this further results in a particularly difficult AI opponent for the user(s) since not only can different decisions be made based on the same or similar collection of data but the AI entity will also “learn” from its previous decisions based on that collection of data so that it continues to make better decisions against the user(s).

Looking now at FIG. 3, illustrated is a flow diagram 300 depicting one embodiment of when and under which circumstances the AI entity's behavioral logic may take action. At step 305, the type of triggers to be evaluated by the AI entity in its decision making process are determined. The types of triggers may be related to the actions (or inactions) of one or more users in the virtual environment, the status of one or more users in virtual environment, the actions (or inactions) of one or more AI controlled non-player characters (NPCs) in virtual environment, the status of one or more AI controlled NPCs in virtual environment, and, importantly, the status of various features of the virtual environment itself.

By evaluating the actual status of the virtual environment, as opposed to just the actions and status of user characters and NPCs in the environment, the decision making process for an AI entity in accordance with the disclosed principles has a distinct advantage over conventional AI engines. More specifically, the disclosed AI engine will periodically evaluate variables and constants in the virtual environment continuously, for example every one or two milliseconds during gameplay, to assist in its decision making process. Accordingly, the decision making process may arrive at different decisions during a given stage of a game based on the environmental analysis even when user characters and/or NPCs have not made an action that would influence the AI entity's decision(s). This is particularly advantageous and unique to a user(s) playing experience when the virtual gaming environment is extremely vast such as within an environment that stretches an entire planet or even an entire galaxy. The experience becomes even more unique when not only are the decisions of the AI entity variable, for example each time the user(s) plays in a particular stage of a game, but even more so when the set(s) of rules employed by the AI entity for its decision making are also variable during gameplay with respect to given set of data points.

In addition to the type of triggers detected by the AI entity, the timing of the AI entity's decision making may also be influenced. For example, the AI entity may interact (i.e., make decisions and take action based on those decisions) in a turn-based interaction with a user or it may interact with the user in a real-time basis where the AI entity does not wait for its turn before acting. If the particular decision of the AI entity is to be made in a turn-based manner (step 310), the AI entity may execute its decision making process and thereby take action either once a user has completed his turn interacting with the virtual environment, as shown at step 315, or when specific events (e.g., triggers) “fire” as described below. Thus, when a user's turn is completed in any of a number ways then the AI entity is triggered and will commence the relevant process so as to act and react to the actions of the user according to the AI's set of rules. As before, this may result in not only the weighting of certain data but also potentially altering the decision making rules themselves either with regard to how weighting is determined or how to act in view of the assigned wright values. It is also possible to create specific events that can occur during the interaction of the user with the graphical environment and which will trigger the AI entity even during the action phase of the user, i.e. without the user having completed his turn. These events may be random, trigger fired, or be part of a sert of rules involved in the game mode. In some embodiments, shown at step 320, a specific exemplary event may be the expiration of a predetermined matter of time for the user to take action, or other type of event that could trigger the AI entity to take action. In the case of such a special event, the AI entity would still implement its decision making process as disclosed herein. Whether the AI entity awaits a user's turn to end or reacts to the occurrence of a special event, the AI entity would execute its decision making process accordingly, as shown in step 325.

In other embodiments, the user is interacting within the graphical environment in real-time (step 330), and his actions have immediate effect. In such embodiments, it is important for the disclosed AI entity to interact with the user and his or her actions in a more immediate manner so as to cope with the rapid changes occurring in the graphical environment due to the user's continuous interaction with the environment. Thus for real-time interaction, the AI behavioral logic will be implemented using one or more triggers depending on the complexity and the needs of the graphical environment. For example, the AI entity may be triggered by every interaction of the user within the graphical environment, as shown in step 335. Additionally, the AI entity may also be triggered every X time as shown in step 340, where X can range, for example, from milliseconds to seconds. Still further, the AI entity may be triggered when specific events are occurring and have been previously defined as AI triggers. Of course, any combination of the above triggers can be used for the AI entity decision making process to be triggered. Once the appropriate triggers are considered, the AI entity makes its decision at step 325.

Referring now to FIG. 4, illustrated is a flow diagram 400 setting forth the assignment of weights on a predetermined number of data items collected from the graphical environment and the interaction of the user with that environment. In order for the AI entity to determine which action or course of actions it will undertake, it will analyze any of a number of factors in the current virtual environment before the decision is made, such as those examples discussed above.

In order to make an effective decision, the AI entity should have a current “view” of the entire situation, as defined by the factors it considers. This analysis can be made by evaluating a certain number of data items from the graphical environment. At step 405 the specific data used to make a decision is collected. As illustrated, the data to be considered can be any number of data items (410a-410e), and such data may or may not be categorized, and even subcategorized, if appropriate. At step 415, the data points to be weighted are identified. In some embodiments, to lessen the load on system, weights can be assigned on each category of the data collected rather than on each data item individually. The importance of each category may be represented with a weight value with high importance of a particular category having higher weight values and lower importance having lower weight values. Moreover, it is possible to create interconnections and dependencies between data items and/or categories, and this can be reflected in the weights assigned.

At step 420, it is determined if the weighting of certain data items or categories is condition dependent. If the weighting of those specific data items is not condition dependent, then the process moves on to step 425 where a predetermined weight value may be assigned for that particular piece of data. If the weight of data is thus concluded, then the process moves on to the decision making process for the AI entity. Alternatively, if the weighting for a data item is condition dependent, the weighting process moves to step 435 where it is determined if the condition has been met. If the condition has not been met, then the weighting process may assign a first weight value to the data item, as shown in step 440. If the condition has been met, then a second weight value may be assigned to that data item, as shown in step 445. For example, if DATA 1 (410a) is within a specific range and DATA 2 (410b) is lower than X value, then DATA 1 will be assigned a weight which will be different than if another condition was met. Once the conditional weighting is concluded, the process proceeds to the decision making process. Depending on the complexity of the set of rules of a graphical environment, the data analysis and the assignment of weights on the data can range from a simple data “tree” to a very long data “tree” with various data “branches”. With the assigning of weights and the interconnections and dependencies between data items, if any, it is possible to create a very elaborate situational analysis report which can be used to trigger specific AI behavioral logic that can include altering the actual rules to be used for the decision making process.

FIG. 5 illustrates a flow diagram 500 setting forth one embodiment of the decision making process of an AI entity according to the disclosed principles. At step 505, the decision making process for an AI entity is initiated. As discussed above, the process may be initiated based on certain triggers occurring in the virtual environment, such as user actions or simply the status of certain parts of the environment being detected during a period of evaluation.

As discussed above, in order for the AI entity to make a decision (act or react in the graphical environment in a certain meaningful way), it needs to first have a situational analysis at the point of decision. Thus, at step 510 the applicable data that has been collected has weight values assigned to them, such as in accordance with the process discussed with reference to FIG. 4. Once all the necessary data have been collected and the relevant weights have been assigned, then the AI entity accesses all the given information and proceeds to the analysis of all those data items as shown in step 515.

At step 520, the AI entity accesses the set or sets of rules to be used in the decision making process. In one embodiment, there exists a specific set of rules which dictates the actions and reactions of the AI entity depending on the results from the analysis of the collected data. In another embodiment, the set of rules can dynamically change depending on the results obtained from the analysis of the collected data. Thus, at step 525, it is determined whether the set(s) of rules to be used is static or dynamic. If the set of decision making rules is static, then the decision making process moves to step 530 where the AI entity compares the weights of the collected data to values compiled in the decision making set of rules, for example, with a weighting algorithm. Based on this algorithmic comparison, the decision making process moves to step 535 where the AI entity follows predetermined instructions that are dependent on the results derived by the relevant comparisons. Once those instructions have been completed, and thus the AI entity has reached a decision based on all of the above factors, the AI entity takes action in accordance with that derived decision as shown in step 540.

If at step 525 it is determined that the set of rules to be followed for the AI entity's decisions making process are dynamic as described above, then some or all the rules of the decision making process can change according to the values of the weights of the collected data. Thus, the decision making process moves to step 545 where the current set of rules to be used are compared to the weighted data items. Based on this comparison, the AI entity may make any adjustments to the rules to be employed as shown in step 550. The decision making process then moves to step 555 where the AI entity compares the weights of the collected data to values compiled in the newly adjusted (if any adjustments have been made) decision making rules. Based on this comparison, the decision making process moves to step 560 where the AI entity follows predetermined instructions that are dependent on the results derived by the relevant comparisons and are in accordance with the adjusted rules of the process. Once those instructions have been completed, and thus the AI entity has reached a decision based on all of the above factors, the AI entity takes action in accordance with that derived decision as shown in step 540.

As a result, the disclosed principles not only provide the capability of adjusting the weight values to be assigned to certain items depending on the AI entity's analysis of the user's interaction and the overall virtual environment as whole, but also providing the capability of adjusting the actual rules to be followed during the decision making process. Thus, the disclosed principles provide a very agile AI behavioral logic that can adapt to the rapid changes in the graphical environment coming from information regarding the graphical environment itself or the user's interaction with the environment. This dynamic decision making process therefore provides a more “intelligent” approach by the AI entity to the events occurring in the graphical environment. Additionally, such an AI entity provides an enhanced challenge to the player since the AI entity would not follow a specific pattern in its actions or reactions but would instead adapt differently each time an event(s) occurs and/or the environment changes, with or without user action.

Turning finally to FIG. 6, illustrated is a flow diagram 600 setting forth an exemplary self-learning process under which an AI entity in accordance with the disclosed principles can improve its decision making process. By implementing a self-learning process as disclosed herein, the AI entity becomes more challenging and more efficient as an opponent to user(s) in a virtual environment.

The self-learning process begins at step 605, where the AI entity has made a decision of action or inaction, for example, following the process as described in detail above. At step 610, it is initially determined if the self-learning process has been enabled in the particular game. If not, the process moves to step 615 where the AI entity simply awaits the next trigger to execute its processes of situational analysis and decision making, as explained above. Also as mentioned above, the trigger may simply be the results of a periodic evaluation of the virtual environment as whole, rather than or in addition to the detection of interactions made by a user(s).

In the case that the self-learning process is enabled, the AI entity will at step 620 identify and store the situational analysis report created prior to the decision that was made. This situation analysis report includes all of the information compiled, weighed, and evaluated by the AI entity when a decision was made. In addition, the decision that was actually made is also identified and stored, at step 625. Additionally, the outcome of the decision that was made is also identified and stored at step 630. For example, the AI entity may perform another situational analysis in order to evaluate the complete effect of the decision that was made, including an evaluation of the user(s) and the virtual environment. All of these pieces of information may be stored in a database or other data storage facility associated with the computer device running the AI decision making engine and/or the computer server hosting the virtual environment. In some embodiments, it is possible to proceed to another situation analysis report after a decision is made by the AI entity in order to record the effects of that decision in the graphical environment. That analysis may or may not include data in addition to the data required by the default situation analysis right before the decision making process, in order to have a better understanding of the decision made by the AI and its implications in the graphical environment.

All of the stored data (for example, the following possible situations: (a) situation analysis report before decision making process, (b) decision made, (c) situation analysis report after a decision is made) constitute a scenario. At step 635, the type and number of scenario(s) are identified. In one embodiment, there is only one category of scenarios that includes specific types of analysis reports and decisions made by the AI entity. In other embodiments, there are several categories of scenarios which can be divided according to the effects that they have on the virtual environment. Accordingly at step 640, it is determined if more than one category of scenarios is present, based on all of the gather information. If only type of scenario is present the process moves on to step 645 where a predetermined set of rules is employed by the AI entity to weigh the scenario. Weight values assigned to scenarios may be based on any of an number of factors, for example, such as the success of failure of the decision made for the given data. Then the process moves to step 650 where the identification and weight of the scenario are stored for future reference.

If, at step 640, it is determined that there are more than one category of scenarios is present, the process moves on to step 655 where a set of rules is employed to categorize the multiple types of scenarios. With the further categorization of scenarios, it is possible to improve the decision making of the AI entity with higher efficiency as decisions and their implications can be connected to specific events in the virtual environment, and therefore it is easier for the AI entity to analyze the outcome of a specific decision. Afterwards, once the scenarios have been categorized, at step 660 another set of rules may be employed to assign weights to the various categories of scenarios. Then the process moves to step 665 where the identification and weight of the various scenarios are stored for future reference. In both cases, in order for the AI entity to determine why one decision made was better or worse than another, each scenario will be given a weight according to a predefined set of rules.

Once weights have been assigned to the one or more scenarios, the process moves to step 670 where various scenarios are compared by the AI entity. More specifically, for a given set of data and the weights assigned to that data, the various results from each of the scenarios are compared so that the AI entity can determine which scenario includes the most optimal results, and which resulted in the least optimal. In the case of more than one category of scenarios, the AI entity may compare the weights of the scenarios under the same category and determine the highest weight, where the highest weight represents the best result. At step 675, the scenarios with, for example, the lowest weights will be flagged as “ineffective,” for example. Consequently, it is highly unlikely that the AI entity will ever use those ineffective decisions for scenarios that are similar to the scenario resulting in the ineffective decision. At step 680, the scenario(s) with, for example, the highest weight will be flagged as “optimum.” Consequently, the AI entity will be more likely to use the decision(s) made in an optimum scenario when scenarios that are similar to the scenario resulting in the ineffective decision occur. As discussed above, the self-learning process can improve the decision making process that the AI entity uses for its behavioral logic and situation analysis logic, and this way improve its effectiveness. Thus, the self-learning process disclosed herein results in a particularly difficult AI opponent for the user(s) since not only can different decisions be made based on the same or similar collection of data, but the AI entity will also “learn” from its previous decisions based on that collection data so that it continues to make better decisions against the user(s).

While various embodiments in accordance with the principles disclosed herein have been described above, it should be understood that they have been presented by way of example only, and not limitation. Thus, the breadth and scope of this disclosure should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically and by way of example, although the headings refer to a “Technical Field,” the claims should not be limited by the language chosen under this heading to describe the so-called field. Further, a description of a technology in the “Background” is not to be construed as an admission that certain technology is prior art to any embodiment(s) in this disclosure. Neither is the “Summary” to be considered as a characterization of the embodiment(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure, but should not be constrained by the headings set forth herein.

What is claimed is:

1. A method of decision making for an artificial intelligence (AI) entity in a graphical virtual environment, the method comprising:
gathering data on which a decision will be based from the virtual environment;
assigning weight values to at least some of the gathered data;
analyzing the weighed data to determine an initial set of decision making rules;
comparing the initial set of decision making rules to the weighted data;
adjusting the initial set of decision making rules based on the comparison to create an adjusted set of decision making rules;
determining a decision based on the weighed data using the adjusted set of decision making rules; and
executing the decision determined using the adjusted set of decision making rules.

2. A method according to claim 1, wherein assigning weight values to at least some of the gathered data comprises using an initial set of weighting rules, the method further comprising:
analyzing the weighted data,
adjusting the initial weighting rules based on the analysis to create an adjusted set of weighting rules, and
re-weighting the weighted data based on the adjusted weighting rules.

3. A method according to claim 1, wherein assigning weight values to at least some of the gathered data further comprises:
identifying if the weighting of one or more of the gathered data is dependent on a precedent condition,
determining if the condition is present for the identified one or more gathered data,
assigning first weight values to corresponding ones of the identified one or more gathered data if the condition is not present, and
assigning second weight values to corresponding ones of the identified one or more gathered data if the condition is present.

4. A method according to claim 1, wherein gathering data comprises gathering data based on user(s) interactions with items or characters in the virtual environment.

5. A method according to claim 1, wherein the method further comprises periodically collecting data pertaining to the status of portions of the virtual environment, the periodically collected data comprising at least a portion of the gathered data.

6. A method according to claim 5, wherein periodically collecting data comprises collecting data pertaining to the status of portions of the virtual environment approximately every two milliseconds, regardless of user(s) interaction with items or characters in the virtual environment.

7. A method according to claim 1, wherein the initial set of decision making rules are determined based on a difficulty level established for the AI entity.

8. A method according to claim 1, further comprising:
identifying an initial scenario based on the weighted data and the executed decision,
evaluating an outcome of the executed decision in the initial scenario,
identifying a second scenario based on new weighted data,
comparing the second scenario to the initial scenario, the second scenario substantially similar to the initial scenario, and
determining a decision to be made for the second scenario based on the evaluated outcome of the executed decision.

9. A method of decision making for an artificial intelligence (AI) entity in a graphical virtual environment, the method comprising:
gathering data from user(s) interactions with items or characters in the virtual environment;
gathering data, on a periodic basis, pertaining to the status of portions of the virtual environment;
assigning weight values to at least some of the gathered data;
analyzing the weighed data to determine an initial set of decision making rules;
comparing the initial set of decision making rules to the weighted data;
adjusting the initial set of decision making rules based on the comparison to create an adjusted set of decision making rules;
determining a decision based on the weighed data using the adjusted set of decision making rules; and
executing the decision determined using the adjusted set of decision making rules.

10. A method according to claim 9, wherein assigning weight values to at least some of the gathered data comprises using an initial set of weighting rules, the method further comprising:
analyzing the weighted data,
adjusting the initial weighting rules based on the analysis to create an adjusted set of weighting rules, and
re-weighting the weighted data based on the adjusted weighting rules.

11. A method according to claim 9, wherein assigning weight values to at least some of the gathered data further comprises:
identifying if the weighting of one or more of the gathered data is dependent on a precedent condition,
determining if the condition is present for the identified one or more gathered data,
assigning first weight values to corresponding ones of the identified one or more gathered data if the condition is not present, and
assigning second weight values to corresponding ones of the identified one or more gathered data if the condition is present.

12. A method according to claim 9, wherein periodically collecting data comprises collecting data pertaining to the status of portions of the virtual environment approximately every two milliseconds, regardless of user(s) interaction with items or characters in the virtual environment.

13. A method according to claim 9, wherein the initial set of decision making rules are determined based on a difficulty level established for the AI entity.

14. A method according to claim 9, further comprising:
identifying an initial scenario based on the weighted data and the executed decision,
evaluating an outcome of the executed decision in the initial scenario,
identifying a second scenario based on new weighted data,
comparing the second scenario to the initial scenario, the second scenario substantially similar to the initial scenario, and
determining a decision to be made for the second scenario based on the evaluated outcome of the executed decision.

15. A computer system providing an artificial intelligence (AI) entity in a virtual gaming environment, the system comprising:
a server device and associated software for hosting a virtual gaming environment;
a data storage for storing virtual entities for use by corresponding users in the virtual environment, and for storing gathered data on which decisions made by an AI engine will be based; and
a computing device and associated software, associated with the server device and data storage, providing an AI decision making engine configured to:
assign weight values to at least some of the gathered data;
analyze the weighed data to determine an initial set of decision making rules;
compare the initial set of decision making rules to the weighted data;
adjust the initial set of decision making rules based on the comparison to create an adjusted set of decision making rules;
determine a decision based on the weighed data using the adjusted set of decision making rules, and
execute the decision determined using the adjusted set of decision making rules.

16. A system according to claim 15, wherein the AI engine being configured to assign weight values to at least some of the gathered data comprises the AI engine:
assigning weight values to at least some of the gathered data using an initial set of weighting rules,
analyzing the weighted data,
adjusting the initial weighting rules based on the analysis to create an adjusted set of weighting rules, and
re-weighting the weighted data based on the adjusted weighting rules.

17. A system according to claim 15, wherein the AI engine being configured to assign weight values to at least some of the gathered data comprises the AI engine:
identifying if the weighting of one or more of the gathered data is dependent on a precedent condition,
determining if the condition is present for the identified one or more gathered data,
assigning first weight values to corresponding ones of the identified one or more gathered data if the condition is not present, and
assigning second weight values to corresponding ones of the identified one or more gathered data if the condition is present.

18. A system according to claim 15, wherein the gathered data comprises data based on user(s) interactions with items or characters in the virtual environment.

19. A system according to claim 15, wherein the AI engine is further configured to periodically collect data pertaining to the status of portions of the virtual environment, the periodically collected data comprising at least a portion of the gathered data.

20. A system according to claim 19, wherein periodically collecting data comprises data pertaining to the status of portions of the virtual environment collected approximately every two milliseconds, regardless of user(s) interaction with items or characters in the virtual environment.

21. A system according to claim 15, wherein the initial set of decision making rules are determined based on a difficulty level established for the AI entity.

22. A system according to claim 15, wherein the AI engine is further configured to:
identify an initial scenario based on the weighted data and the executed decision,
evaluate an outcome of the executed decision in the initial scenario,
identify a second scenario based on new weighted data,
compare the second scenario to the initial scenario, the second scenario substantially similar to the initial scenario, and
determine a decision to be made for the second scenario based on the evaluated outcome of the executed decision.
